(19) United States
(12) Patent Application Publication
(10) Pub. No.: US 2011/0085443 A1
(43) Pub. Date: Apr. 14, 2011

(54) Packet Analysis Apparatus

(75) Inventor: Hiroaki Shikano, Tachikawa (JP)

(73) Assignee: Hitachi. Ltd., Tokyo (JP)

(21) Appl. No.: 12/994,355

(22) PCT Filed: Jun. 1, 2009
(86) PCT No.: PCT/JP2009/059995

§ 371 Date: Nov. 23, 2010

(30) Foreign Application Priority Data
Jun. 3, 2008 (JP) 2008145264

(51) Int. Cl. H04L 12/56; H04L 12/26

(52) U.S. Cl. 370/235; 370/252

(57) ABSTRACT

As networks have spread, various services such as video streaming and IP telephone have been achieved. Along with that, complexity of networks has advanced, but there have not been a way to manage all packets distributed on networks, and thus quality guarantee and reliability securement have been problematic. Also, an increase in cost such as recovery solution upon a failure has been a big problem. Accordingly, an IP probe which detects packets distributed on communication paths in real time and visualizing a status of the network is achieved by a heterogeneous multi-core processor including a dynamic reconfigurable processor. By changing configuration function in a packet analysis depending on characteristics of the packets, low power and high performance are achieved with flexibly handling various standards and services.

Also, by allocating a plurality of nodes, a status of the whole network is visualized. In this manner, a low-power and small IP probe node is achieved, and, by arranging a plurality of the IP probe nodes on a network, movements of packets distributed on the network, which have been impossible to be observed, can be grasped in real time, and thus an improvement in network quality and a reduction in maintenance management cost are achieved.

### TECHNICAL FIELD

The present invention relates to a packet analysis apparatus as an instrument of efficiently analyzing packets transiting through networks, the packet analysis apparatus visualizing the status of the network using a heterogeneous multi-core processor including a dynamic reconfigurable processor.

### BACKGROUND ART

Networks have rapidly spread. The broadband penetration in homes has already exceeded 50%, and various services are being provided. Network traffic is steadily increasing and the networks is now an important infrastructure for out daily life as traffic have shifted from past text-oriented traffic for e-mail, web browsing, etc. to traffic through which exponentially larger volume of data for video streaming service, IP telephone etc. is transferred. However, previous networks based on the Internet are best-effort type of services and ensuring its quality is a big problem. For example, how to achieve a quality assurance (Quality of Service: QoS) of IP phone and video streaming etc. and how to ensure reliability to failure are becoming differentiators of networks. In the trend, construction of a next generation network (NGN) has been under way aiming at dealing with advanced services such as QoS assurance of telephone and video streaming etc. and assurance of security of communication contents.

In addition, such a situation also goes to not only intranets which telecommunication carriers (carriers) provide but also intranets installed inside organizations such as companies. To control QoS or enable automatic management, expensive router apparatuses are required and it is difficult to introduce such apparatuses in view of costs. However, what happens is that the maintenance management of networks is high in cost.

Also, as the broadband penetration rate in homes is being increased, connections of various home information appliances such as digital TVs to networks have started. For example, in addition, LAN connection terminals are provided to appliances such as digital video recorders, IP telephones, PCs, audio equipment, cameras, etc. and the situation is changing that such appliances are connected to the Internet via home networks. As to construction of home networks, networking of home appliances has been advanced as communications using power-supply lines (power line communication: PLC) system have started spreading. A home gateway or a home router is disposed at the interface of the home network and the external network, and the firewall function aiming at security and a packet forwarding function among a plurality of appliances and the external network are provided.

Further, as to the in-house intranet, a cost reduction in maintenance management is particularly important. To use the intranet for business purposes, reliability of the network at a high level is required. Backbone network to which high reliability is required often introduces a sophisticated router capable of packet analysis and failure detection etc., but edge networks used for general business or networks used for general work are often constructed by single-function routers and hubs for household use. In such networks, when a problem of failure etc. occurs, it takes tremendous amount of time for research to probe a cause of the problem.

The inventor of the present invention have researched prior art documents regarding packet analysis and failure detection in networks. A summary of the research is as follows.

As appliances such as routers which perform network processings such as packet analysis and route search etc. require very high-performance computing, the processings have been conventionally executed by dedicated hardware. However, there are problems such that changes of packet processing systems along an introduction of new services etc. cannot be dealt with. Accordingly, a reconfigurable device (dynamic reconfigurable processor) has been proposed, the reconfigurable device being capable of flexibly switching functions while giving performance close to that of dedicated hardware by arranging a plurality of computing cells and dynamically reconfiguring functions and wirings. For example, Patent Document 1 discloses an aspect of a reconfigurable device configured by a plurality of arithmetic elements, wirings connecting the elements, and switches connecting the wirings. Also, Patent Document 2 discloses an aspect of a reconfigurable device including wirings which couple elements adjacent to a plurality of computing elements, a circuit which controls function of the arithmetic elements, and a memory.

Systems of increasing a speed of a network processing by using such a reconfigurable device have been proposed. Patent Document 3 discloses a system for searching for the shortest path between nodes included among networks. Also, Patent Document 4 discloses a device which searches for relay destination address from destination address of a packet. Upon searching for relay destination address, address information to be a compared object is set on the reconfigurable device, and a comparison is performed with switching the information so that a means of searching at a high speed is provided. Moreover, Patent Document 5 provides a means of performing control for determining transfer, discard, etc. regarding a packet processing in networking equipment of a router etc. by a cooperation of a reconfigurable device and a general-purpose processor.

### Prior Art Documents

Patent Document 1: WO02/095946
Patent Document 2: Japanese Patent Application Laid-Open Publication No. 2006-139670
Patent Document 3: Japanese Patent Application Laid-Open Publication No. 2007-306442
Patent Document 4: Japanese Patent Application Laid-Open Publication No. 2007-013856
Patent Document 5: Japanese Patent Application Laid-Open Publication No. 2005-117290

### DISCLOSURE OF THE INVENTION

### Problems to be Solved by the Invention

Problems to be solved by the invention are as follows.

Considered causes of an expensive cost of maintenance management, repair and maintenance of networks are as follows.

First, there is a problem that, when a failure occurs in a network appliance or a network inside a corporation or a building, it takes tremendous amount of time and personal costs to grasp causes to solve the failure. Because, when a communication failure is received from a user, a network administrator should connect a device for analyzing the status of the network to a network appliance provided to the user's side and work on the analysis on site. Second, the failure is generated by complex causes and there are poorly-reproducible cases, and so it is difficult to find the causes, and also, there is a difficulty in a root cause analysis in complex systems. For example, when users cannot get quality of service, it is necessary to analyze what is the root cause is from a problem in an appliance such as a server on the service provider's side, a problem in a communication path, or a problem in an appliance on the user's side. However, there is no means for the administrator to know the network status for conducting a root cause analysis in real time.

Thus, to solve the above-mentioned problems, a mechanism to “visualize” the status of the network for easing analysis of failure and finding a bottleneck path on the network is necessary by detecting packets flowing on the communication paths in real time and grasping a traffic volume and/or an inter-node communication time (latency) as a whole of the network in real time.

Meanwhile, such a means of grasping a traffic volume and/or an inter-node communication time (latency) as a whole of the network does not exist at present. No configuration for solving the above-mentioned problems has been found in the above-mentioned Patent Documents.

### Means for Solving the Problems

The typical ones of the inventions disclosed in the present application for solving these problems mentioned above will be briefly described as follows.

An IP probe including a processor including a first processor core which is a general-purpose processor and a second processor capable of dynamically reconstruct components, wherein, upon receiving a packet, first information is extracted from a header from the packet, and components of the second processor core is reconfigured based on the first information.

A method of processing a packet for an IP probe arranged on a network, the method including: a first step of extracting first information from a header of a packet received by the IP probe; a second step of determining a next configuration of a processor core included in the IP probe based on the first information; and a third step of switching the processor core to a configuration determined in the second step.

### EFFECTS OF THE INVENTION

According to the present invention, an improvement in network quality, a reduction in maintenance management cost, etc. can be achieved.

### BRIEF DESCRIPTIONS OF THE DRAWINGS

FIG. 1 is a diagram illustrating an example of a configuration of an IP probe;

FIG. 2 is a diagram illustrating an example of a configuration of an IP probe;

FIG. 3 is a diagram illustrating an example of a configuration of an IP probe;

FIG. 4 is a diagram illustrating a configuration example of a hetero multi-core processor for IP probe processing;

FIG. 5 is a diagram illustrating a configuration example of a hetero multi-core processor for IP probe processing;

FIG. 6 is a diagram illustrating a configuration of a dynamic reconfigurable processor;

FIG. 7 is a diagram illustrating a configuration example of a corporate network in which an IP probe is used;

FIG. 8 is a diagram illustrating a configuration example of a home network in which an IP probe is used;

FIG. 9 is a diagram describing a flow of an IP probe processing as a whole;

FIG. 10 is a diagram illustrating a packet analysis processing flow on a dynamic reconfigurable processor;

FIG. 11 is a diagram illustrating a configuration of a statistics table;

FIG. 12 is a diagram illustrating a method of an IP probe parallel processing on a hetero multi-core;

FIG. 13 is a diagram illustrating a network configuration example when a plurality of IP probe nodes are arranged;

FIG. 14 is a diagram illustrating a configuration of a management table of a cooperation among IP probe nodes; and

FIG. 15 is a diagram illustrating an example of a network status display.

### DESCRIPTION OF SYMBOLS

101, 102 . . . Physical layer chip; 103, 104 . . . LAN controller; 105 . . . Memory; 106 . . . Processor; 107 . . . Packet processor; 108 . . . Memory; 111, 112 . . . Processor; 113, 114, 115 . . . Memory; 121, 122, 123, 124 . . . General-purpose processor; 125, 126 . . . Accelerator; 127 . . . Centralized shared memory; 128 . . . Data transfer controller; 129 . . . Memory controller; 130 . . . Memory; 131 . . . LAN controller; 132 . . . IO interface; 133 . . . Inter-chip bus; 140 . . . General-purpose processor core; 141, 144 . . . Local memory; 142, 146 . . . Power control register; 143, 147 . . . Data transfer unit; 145 . . . Accelerator core; 151, 152 . . . Memory controller; 153, 154 . . . Memory; 155, 156 . . . LAN controller; 160 . . . Sequencer; 161 . . . Computing array portion; 162 . . . IC interface; 163 . . . Crossbar network; 164 . . . Configuration manager; 165 . . . Load store cell; 166 . . . Local memory; 167 . . . Bus interface; 180 . . . Corporate network; 181 . . . External network; 182, 184 . . . Router embedding IP probe; 183 . . . Server; 185, 190, 191 . . . Unit; 186, 189 . . . IP probe; 187 . . . Router; 188 . . . Terminal; 200 . . . External network; 201 . . . Server; 202 . . . Gateway; 203 . . . Internal network; 204, 210 . . . Home; 205 . . . IP probe; 206, 211 . . . Gateway; 207 . . . Digital TV; 208 . . . Computer; 209 . . . IP phone; 220 to 221, 223, 225 to 230 . . . Processing; 244 . . . Processing including branch; 240 to 243 . . . Processing; 244 . . . Processing including branch; 250 . . . Transfer source IP address; 251 . . . Transfer destination IP address; 252 . . . Transfer source port; 253 . . . Transfer destination port; 254 . . . Protocol; 255 . . . Packet number; 256 . . . Packet data volume; 257 . . . Number of packets per second; 258 . . . Packet data value per second; 259 . . . Information of flow eigenvalue; 270 to 279 . . . Processing; 290 to 294 . . . IP probe; 300 . . . Device ID; 301 . . . Connected device ID; 302 . . . Connection port; 303 . . . Average packet data value; 304 . . . Average packet number; 305 . . . Average packet transit time; 306 . . . Status; 310 . . . Average amount of packet data; 311 . . . Average packet transit time; 312 . . . Circle graph illustrating a network bandwidth usage status; 313 . . . Service server; and 314 . . . IP probe.

### BEST MODE FOR CARRYING OUT THE INVENTION

Hereinafter, embodiments of the present invention will be described in detail. An IP probe is a system for visualizing movements of packets flowing on a network and for grasping the status of the network in real time. Packet is a unit of dividing data flowing in the network. That is, upon performing a communication service (for example, file transfer), servers and client appliances connected to the network divide data to be transferred/received by the service into a plurality of packets to send the data on the network. In the situation, packet groups being attributed to the same communication service are called “flow.” Upon a packet division, information related to a decision of a packet delivery path, such as destination information based on the flow to which the packet is attributed to is added to a header portion of the packet. The IP probe analyzes the header information of the packet received by the system and extracts information indicating a packet attribute such as a transfer source address, a transfer destination address, a protocol type, a transfer source port number, a transfer destination port number, etc. so that the flow to which the packet is originally attributed to is identified from a combination of the information. By grasping movement of the flow, it becomes possible to conduct a failure detection, quality control, detection of abnormal communication flow, etc.

<Configuration of IP Probe>

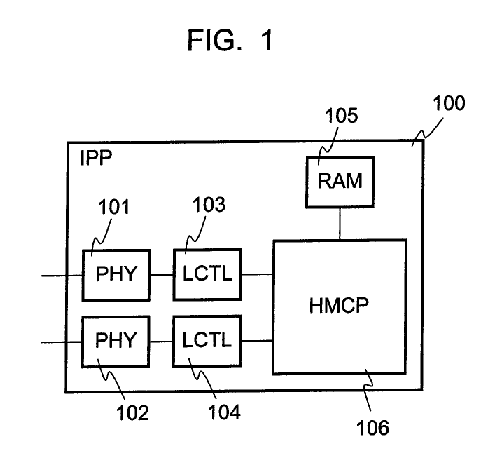

A configuration of an IP probe is illustrated in FIG. 1. The system is connected to a network (LAN) and configured by: physical layer chips (PHY) 101 and 102 which receive physical electric signals and convert the same to digital signals; LAN controllers (LCTL) 103 and 104 which control transfer and reception of packets; a processor (HMCP) 106 which performs a packet analysis; and a memory (RAM) 105 which stores packet data, data in processing, program, etc.

Two ports are prepared for PHY and LCTL and installed by inserting them to an existed network. Also, since communications on the network are multiplexed in upstream and downstream, it is possible to receive packets by dividing them by upstream and downstream using the two ports.

The LCTL is connected to an input/output terminal for a peripheral device extension such as PCI Express. The HMCP analyzes received packets and generates statistical information and/or performs processing of bandwidth control, abnormal flow detection, etc. The RAM corresponds to a volatile memory such as DRAM which retains temporary data, a non-volatile memory or a ROM which stores program etc.

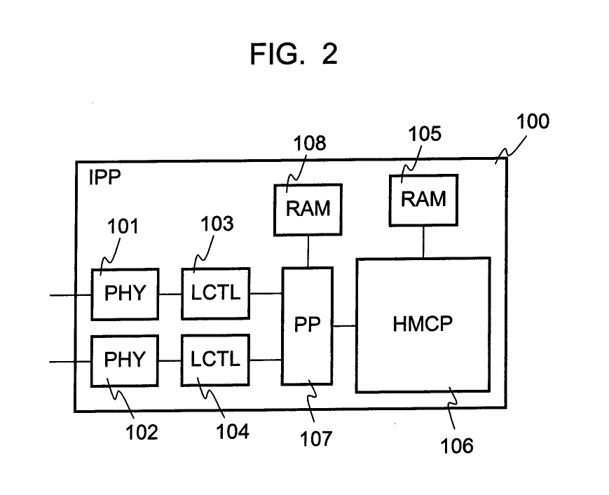

In addition, as another configuration, a configuration to which a packet processor (PP) 107 which only performs a packet processing can be considered. A configuration diagram of the IP probe to which the PP is added is illustrated in FIG. 2. As illustrated in FIG. 2, by separating packet processings such as separation of the header portion of the packet, transfers among packet ports, etc. by the PP, a reduction of processing load of the HMCP and a usage of a transfer bandwidth can be possible. For example, the packet received at the PHY 101 and the LCTL 103 is separated from the packet header information at the PP and the header information is transferred to the HMCP. The packet is temporarily stored in a packet buffer (RAM) 108 connected to the PP. The HMCP analyzes the header information and transfer the same to the PP with command of controlling the PP while adding new header information if necessary. The PP updates the packet data which has been temporarily stored in the RAM and transfers (sends) the packet at the LCTL 104 and PHY 102.

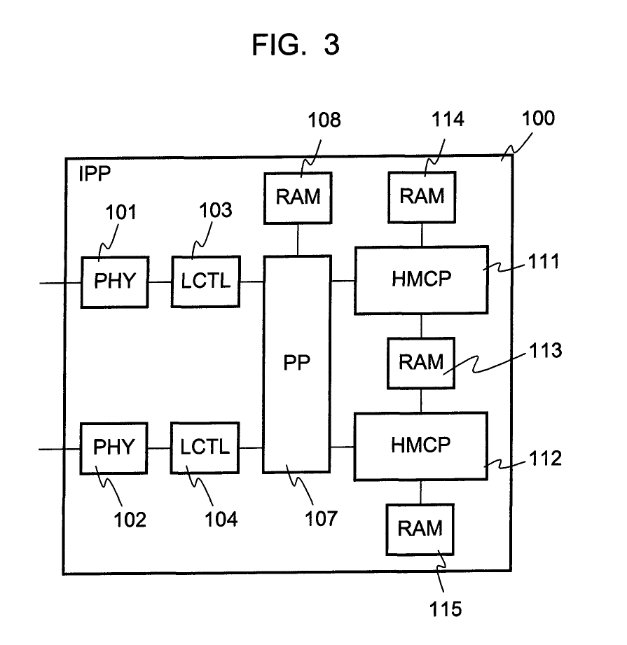

Also, when more performance of the HMCP such as a complex packet analysis or packet control using statistical information is required, the configuration may be a multi-tip configuration of the PP and the HMCP. A configuration diagram of an IP probe in which the PP and the HMCP are multi-chipped is illustrated in FIG. 3. FIG. 3 is a configuration in which two HMCP are connected to a PP. For example, regarding a packet received by the PHY 101 and the LCTL 103, the packet body is temporarily stored on the RAM 108 and packet header information is transferred to an HMCP 112. In this manner, by allocating data of different ports to different HMCPs by the PP, load of the HMCP can be dispersed. An HMCP 111 and the HMCP 112 are connected to memory RAMs 114 and 115, respectively, and commonly connected to a RAM 113 for interchip communication.

<Configuration of HMCP>

Subsequently, a configuration example of an HMCP used in an IP probe in the present embodiment will be described. HMCP is a processor which analyzes packets. Each packet can be processed in parallel as there is no data dependency of deciding an order of processing. Thus, it is preferable for the HMCP to use a multi-core processor mounting a plurality of processor cores.

In a multi-core processor, a plurality of processor cores are operated in parallel with a lowered clock frequency and an operation voltage, thereby achieving a superior power performance (high performance, low power). Also, by introducing a dedicated processor (accelerator) which efficiently performs a specific processing to have a multi-core processor having a heterogeneous configuration, a further improvement in power performance can be achieved.

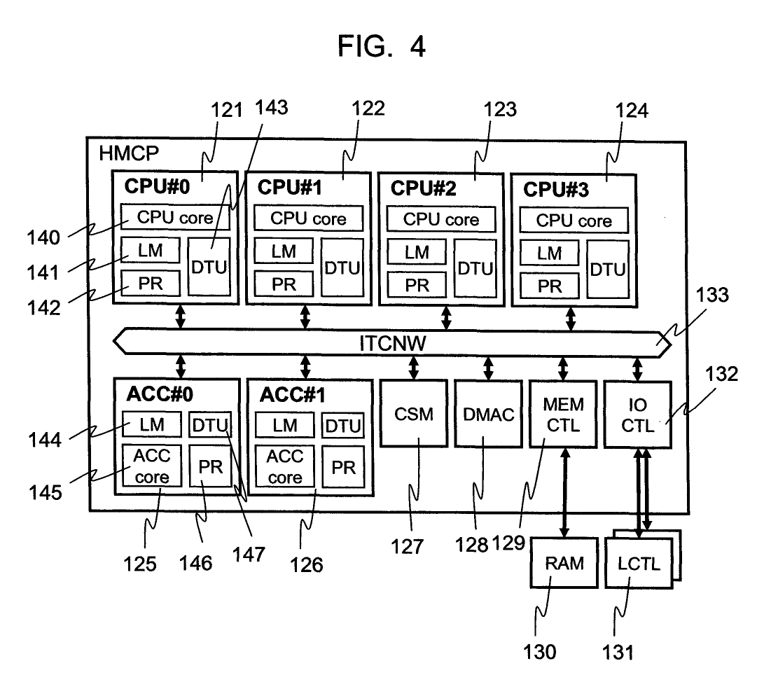

A configuration example of an HMCP is illustrated in FIG. 4. In this example, four general-purpose processors (CPU) 121, 122, 123, and 124 and two accelerators (ACC) 125 and 126 are mounted. Each core mounts high-speed local memories LM 141 and 144, and its processing performance can be improved by locating frequently accessed data to the LM. Also, in the same manner, each processor core includes data transfer units DTU 143 and 147 for transferring data from an external memory RAM 130. In addition, power control registers PR 142 and 146 which set clock frequency and/or power voltage of each core are provided. The HMCP further mounts: a concentrated shared memory (CSM) 127 which arranges data to be shared among the processor cores; a memory controller (MEMCTL) 129 which connects an external memory; a peripheral device connection interface (IOCTL) 132 which connects a packet processor PP and/or a LAN controller LCTL 131; and a data transfer controller (DMAC) 128 which transfer data among the RAM 130 and the LM 141 and 144. The processor core, memory, various controllers and interfaces are mutually connected through an inter-chip bus (ITCNW) 133.

A simple flow of an IP probe processing on the HMCP described above will be described. Packets received at the LCTL 131 or header information segmented by the PP are transferred to the LM 144 of the ACC or the LM 141 of the CPU via the IOCTL 132 and the ITCNW 133 by the DMAC 128 or the DTU 143 and 147 of each core, and an analysis processing is carried out on the ACC or CPU. After the analysis processing is finished, either of the CPU 121 to 124 determines a next processing content based on a result of the analysis processing and a CPU or an ACC having a margin to carry out the processing content is decided. The DTU 143, 147 on the CPU or ACC to which the decision processing has been carried out transfers the analysis result to the LM 141, 144 of a CPU or ACC which next performs the process. Then, a configuration of the ACC described later is reconfigured based on an analysis result.

As described in the foregoing, a feature of the IP probe of the present embodiment is that the IP probe analyzes header information on the HMCP, decides a next processing based on a result of the analysis processing, and reconfigures the ACC to a configuration corresponding to the next processing. By using such a configuration, a configuration suitable for packets for processing each ACC can be achieved, and the ACC can efficiently process packets, and thus a low-power and high-performance multi-core processor can be achieved. In the configuration of the ACC, loading can be performed from the concentrated shared memory CSM and/or the external memory RAM provided on the IP probe.

<Another Configuration of HMCP>

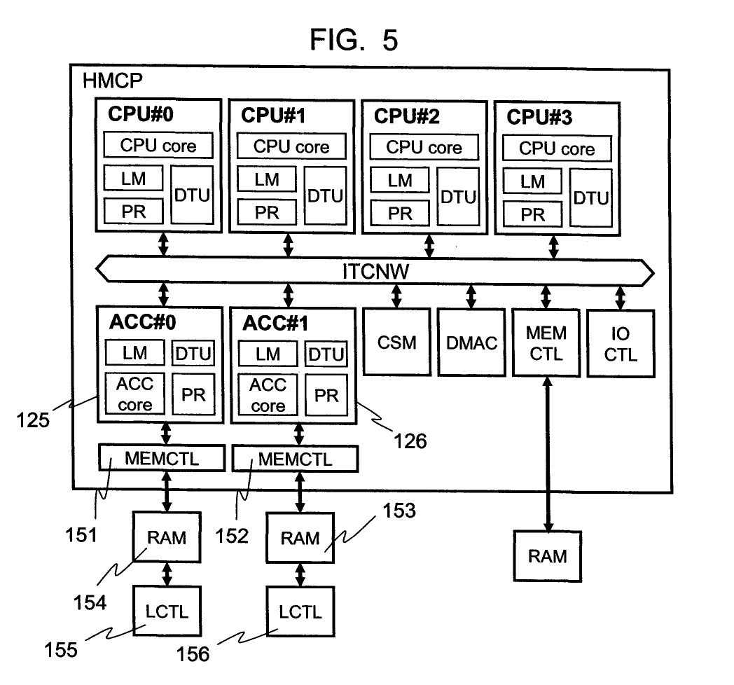

The foregoing has been one configuration example of an HMCP, and for example, a number of processors, a type of an accelerator, a number of cores are decided depending on aimed function and/or performance. Also, a function for leveraging other external interfaces such as image display can be also provided. FIG. 5 illustrates a configuration diagram of an HMCP when an interface to an LCTL or a PP is directly coupled to an accelerator ACC. In the present configuration, the LCTL or the PP 155, 156 is directly connected to the ACC 125, 126 via a buffer memory RAM 153, 154 and a memory controller MEMCTRL 151, 152. Since the ACC can directly access data on the RAM, it is possible to efficiently process data on the RAM at the ACC. In a processing by the present configuration, packets received by the LCTL or header information segmented at the PP is programmed in the RAM 153, 154. The ACC 125, 126 on the HMCP perform a packet analysis processing with continuously retrieving packets on the RAM 153, 154. After the analysis processing is finished, a management CPU determines a next processing content based on a result of the analysis processing, and decides a CPU or ACC having a margin for a processing for carrying out the processing content. A DTU on the ACC to which the decision processing has been performed transfers the analysis result to an LM of a CPU or ACC which will carry out the processing next.

As described above, as compared with the configuration in FIG. 4, the configuration of the HMCP in FIG. 5 has a feature that an accelerator ACC can directly access an external RAM via a memory controller MEMCTL. According to the feature, data on an external RAM can be processed at an ACC. Also, since the ACC can directly access an external RAM, load on an inter-chip bus can be reduced as compared with the embodiment in which the access passes through an inter-chip bus. According to these effects, a further improvement in a multi-core processor can be achieved.

<Configuration of Accelerator>

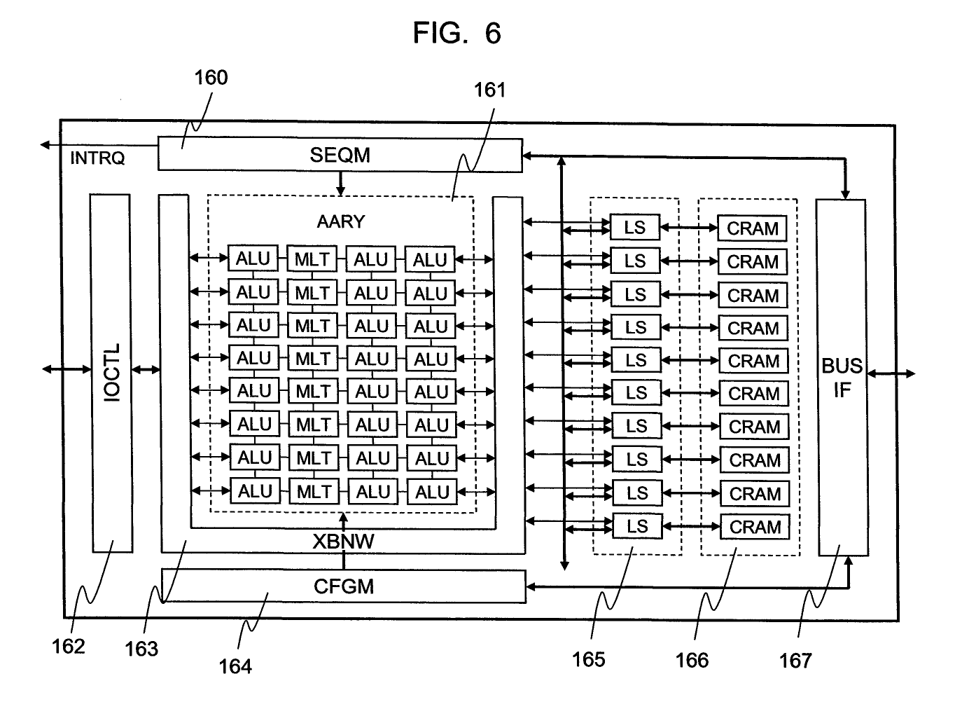

As a specific configuration example of an accelerator which the HMCP has, a dynamic reconfigurable processor (DRP) is illustrated in FIG. 6. The DRP is configured by a computing cell array in which ALUs capable of dynamically changing functions are connected in a two-dimensional array manner. The present DRP is configured by three elements of a computing processing portion, a computing control portion, and a bus interface. The computing processing portion includes: a computing cell array (AARY) 161 in which computing cells which carryout an arithmetic-logic computing are two-dimensionally connected; a local memory (CRAM) 166 which stores computing data such as a computing operand and a computing result; a load store cell (LS) 165 which carries out an access address generation and a read/program control to the local memory; and a crossbar network (XBNW) 163 which connects the computing cell array and the load store cell. The computing cell array AARY 161 has a two-dimensional computing cell array structure formed of 32 pieces of general-purpose computing cells (arithmetic-logic computing cells (ALU)×24 pieces and multiplication cells (MLT)×8 pieces). Each cell is connected by adjacent wiring, and software can change function of each cell and connection of adjacent wiring. A software description for deciding the function and wiring connection is called “configuration.”

Also, the computing control portion is configured by a configuration manager (CFGM) 164 which controls an operation content and an operation state of the computing processing portion and a sequence manager (SEQM) 160. The CFGM 164 performs memory and management of configuration information and the SEQM 160 controls an order of carrying out a plurality of configurations. Also, the bus interface is configured by a bus interface (BUSIF) 167 which performs a connection with an inter-chip network ITCNW and an extension interface (IOCTL) 162 which connects to another DRP for extending a large-capacity memory and/or computing cell array size.

<System Configuration Diagram upon Allocating to Network>

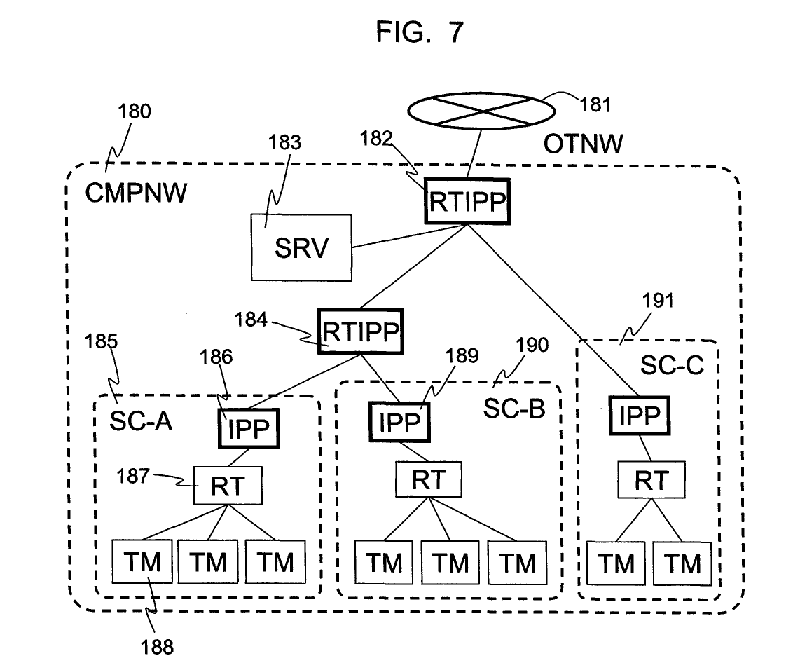

Next, a configuration of a system which visualizes a status of a network as a whole by allocating a plurality of IP probes to the network will be described. FIG. 7 illustrates a network configuration diagram when allocating IP probes to a network CMPNW 180 to be laid in organization such as a company. In the CMPNW 180, routers RT are allocated section-by-section (SC-A 185, SC-B 190, SC-C 191) and terminals TM of each section are connected. In addition, a higher-level router RTIPP 184 is allocated on a communication paths among sections, and appliances such as a server SRV 183 is further connected, and the router RTIPP 184 is connected to an external network OTNW 181 via a router RTIPP 182 at the highest-level layer.

The server 183 not only provides various services such as file transfer etc. to terminal but also performs management and/or control such as setting operations of IPP and RTIP provided to the CMPNW 180, and also has a role of providing information of the whole network to a manager by aggregating network statuses from each IPP, RTIPP.

An IP probe IPP 186 is added to a communication path which traces packets among the communication paths of existed networks, or embedded in a network appliance (RTIPP) such as a router to which the communication path is connected. For example, in a corporation network CMPNW, to grasp a communication status of a network in a section SC-A 185, the IP probe IPP 186 is placed in a upstream communication path of the router RP provided to the SC-A.

In this manner, it becomes possible to grasp communications between a terminal appliance TM 188 in the SC-A and the server 183 and/or an external network OTNW 181, or movements of packets in communications with terminals TM in the different section SC-B 190.

<Allocation Diagram in Home Network>

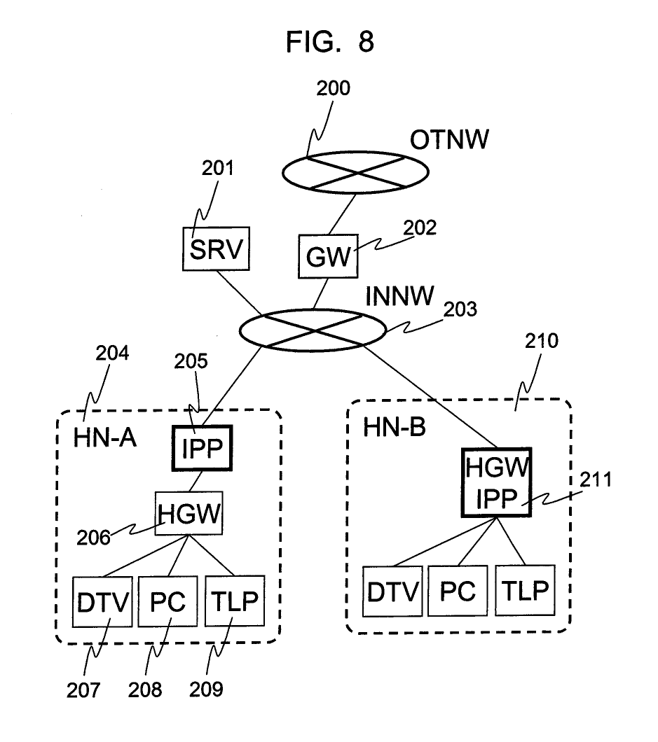

Next, a configuration diagram when using an IP probe for a home network is illustrated in FIG. 8. A telecommunication carrier who provides communications infrastructure builds an INNW 203 and provides communication lines to each home HN-A 204, HN-B 210. The INNW 203 is connected to an external network OTNW 200 such as the Internet via a gateway GW 202. To the INNW 203, a server SRV 201 for providing various services such as mail, WEB, video streaming by the telecommunication carrier is connected.

In each home, a gateway HGW 206 is allocated as a connection port between the INNW 203 and a home network to connect communication devices in home. To the HGW 206, communication devices such as a digital television DTV 207, a personal computer PC 208, an IP telephone TLP 209 are connected. Each communication device carries out exchange of packets with servers and/or various communication devices on the INNW 203 or servers and/or various communication devices connected to the OTNW via the HGW 206.

An IP probe IPP 205 is allocated in a communication path connecting the HGW 206 and the INNW 203, or allocated to be embedded in the HGW as (HGWIPP) 211, and traces exchanged packets between home devices and the INNW, the server on the OTNW, and communication devices. As a result, when a failure that in-home communication devices cannot communicate occurs, the telecommunication carrier can investigate whether the problem is on the provided network on the carrier's side or the problem is in the in-home network and communication device by accessing the IPP 205 and/or the HGWIPP 211. Also, bandwidth reservation of various communication devices can be set. For example, for usage of video streaming on a digital television and IP telephone, it is necessary to ensure a certain level or more of bandwidth for each service to maintain service quality. As a user sets using bandwidth and/or priority of each service to the IPP, a packet communication traffic can be controlled by the IPP 205 or the HGWIPP 211 based on the set bandwidth information.

<Process Flow of Whole Processing>

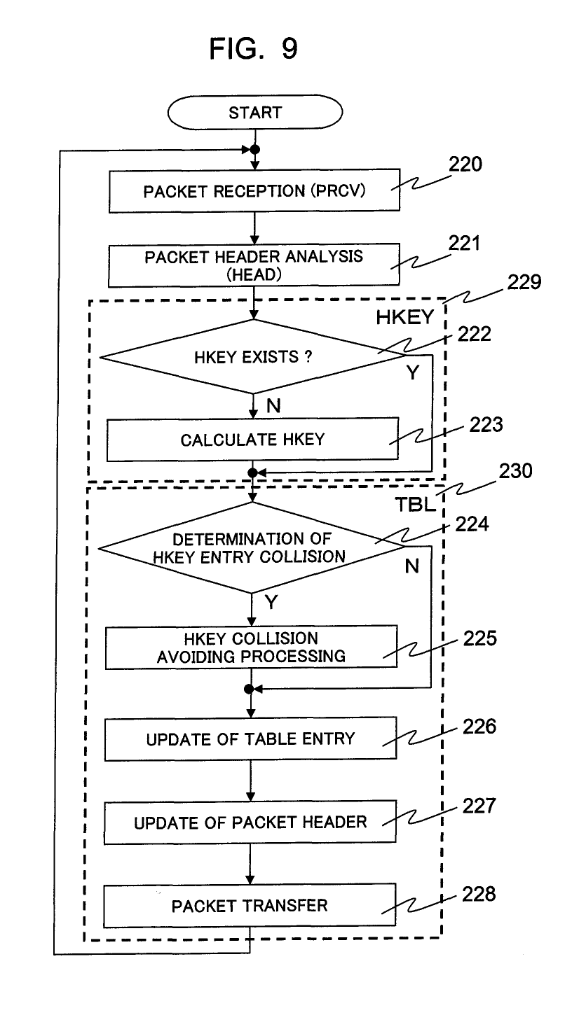

Subsequently, a whole processing flow of the IP probe will be described with reference to FIG. 9. First, when a packet is received at the LCTL 103, 104, reception of the packet is notified to the PP 107 or the HCMP 106, 111, 112 by an interrupt etc. (PRCV). The PP separates a packet header from the packet body, and the packet body is temporality retained on the RAM 108 connected to the PP. The HMCP transfers the header portion separated from the PP to the HMCP upon receiving an interrupt of packet reception.

Subsequently, a packet header analysis is carried out (221). After analyzing the header, whether a flow eigenvalue HKEY for discriminating packet flows is added to the packet header or not is determined (222). This is because it is not necessary to calculate HKEY when the HKEY is added to the packet header by another IP probe. When the HKEY is not added, derivation of the HKEY is carried out (223). The HKEY is obtained by using a hash function using the extracted header information as a key. While an entry of a flow is added to a statistical table held in the RAM of the IP probe, if the HKEY is identical but the flow is different (if there is a collision of HKEY 224), HKEY is replaced (HKEY collision avoiding processing 225). A method of the replacement is to add an identifier to a key of the header information and use the same in the hash function again.

In the manner as described above, the process flow of the present embodiment has a feature in the point that whether the flow eigenvalue HKEY, which is a value for determining which flow a packet belongs to upon receiving the packet, is added to a packet header or not is determined, and, if not, a HKEY is derived and added. According to the feature, it is possible to perform the derivation of the flow eigenvalue only when it is necessary, and also it is possible to surely analyze a packet using a flow eigenvalue.

Subsequently, the entry in the statistical table is updated (226) and the HKEY is added to the packet header and the header is transferred to the PP, and the packet body is reconfigured on the PP (227) and sent to the LCTL with control instruction for sending the packet, so that the packet is sent (228).

<Method of Packet Analysis Processing by Accelerator>

In the whole flow described above, the packet analysis processing and the processing for obtaining a flow eigenvalue are carried out by a dynamic reconfigurable processor which is an accelerator included in the HMCP in the present embodiment. Here, a method of carrying out a packet analysis processing for extracting target information from a packet header by a DRP will be described. The packet analysis is a processing of extracting various information allocated at predetermined position from a bit sequence composing a packet header.

The header information specifically has the following identification information and attribute information. While a network packet is hierarchized into seven layers by a standardized OSI (Open Systems Interconnect) reference model, the network packet is assumed to be a device which analyzes header information defined by a three-layer network layer and a four-layer transport layer in the present embodiment.

In the network layer, information required for routing different network segments such as routers is defined. For example, there is IPX (Inter-network Packet eXchange) used in IP (Internet Protocol) and NetWare used in TCP/IP. When a header, by which the packet identifies a network layer, indicates an IP packet, in the network layer of IP, transfer source IP address, transfer destination IP address, a data length, etc. are defined.

Also, the transport layer handles function of connection establishment, error recovery etc. for providing a trustworthy end-to-end packet delivery. For example, there are TCP (Transport Control Protocol) which achieves a highly trustworthy data transfer/reception accompanied with a delivery confirmation, UDP (User Datagram Protocol) which achieves a high throughput while it is less trustworthy without delivery confirmation, etc. In the TCP and UDP, communication port numbers used by services such as high-level FTP (File Transfer Protocol) and HTTP (Hyper Text Transfer Protocol) are defined.

In the DRP, one piece of attribute information and identification information are extracted in one configuration. By changing the configuration, different attribute information and identification information are extracted. As described above, since the packet information is hierarchized, after extracting one piece of information, attribute and identification information to be extracted next may be decided based on the information. For example, extracting object is different in an IP protocol and an IPX protocol in a network layer. Also in a higher-level transport layer, for example, information of the extracting object is different in the TCP and UDP. In addition, since the DRP has a configuration in which the computing array is connected to memories divided into a plurality of banks, it is possible to process a plurality of packets in parallel.

Thus, by carrying out processing while changing configurations like the DRP, a plurality of packets can be efficiently subjected to an analysis processing, and also it is possible to be flexibly compatible to various protocols and regulations.

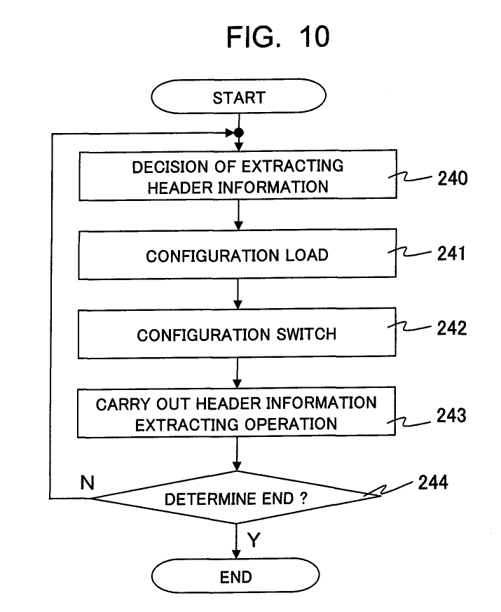

A basic flow of the packet analysis by the DRP is illustrated in FIG. 10. When the packet analysis processing is started, target data to be extracted is first decided (240), a configuration for extracting the data is loaded to an array on the DRP (241), and a function switching matching the configuration is performed (242). Then, a computation of extracting attribution/identification information is carried out (243). Next, from the extracted data, target data having attribution/identification information to be extracted next is decided, and carrying out the configuration load and extraction are repeated in the same manner (244).

While the DRP has a function of carrying out a configuration load in parallel with computation on an array, by pre-loading during a packet extraction when, for example, next extracted data is the same as packet data previously extracted to a packet target, the configuration load can be shielded. Normally, in file transfer and streaming etc., packets in the same attribution are often transferred. Accordingly, such a pre-load of configuration is effective.

<Statistical Table to be Retained>

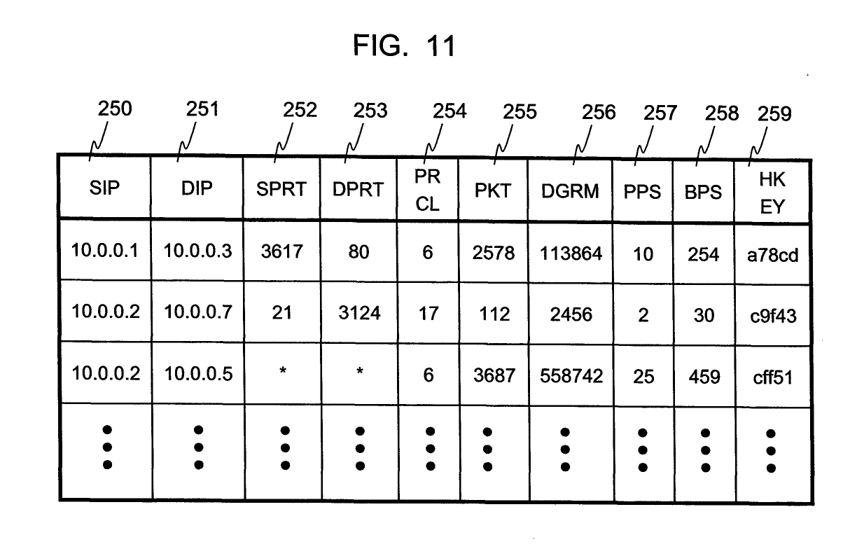

Subsequently, a statistical information table created by the IP probe will be described. An example of creating a statistical table in the present embodiment is illustrated in FIG. 11.

In the present example, by a packet analysis, IP address (SIP), transmission destination IP address (DIP), transmission source port (SPRT), transmission destination port (DPRT), protocol (PRCL), packet data size etc. are extracted targeting an IP packet, and information pieces such as SIP 250, DIP 251, SPRT 252, DPRT 253, PRCL 254, a number of total packets (PKT) 255, a total packet data size (DGRM) 256, a number of packets per second (PPS) 257, a packet data volume per second (BPS) 258, flow eigenvalue (HKEY) 259 etc. are recorded as a statistical information table.

As described above, features of the IP probe of the present embodiment are that the IP probe extracts data such as transmission source IP address, transmission destination IP address, a transmission source port, a protocol, a transmission destination port or a packet data size etc. by the packet analysis, and the IP probe creates a statistical table recoding these information pieces and information of a total number of packets, a total packet data size, a number of packets per second, a packet data volume per second, a flow eigenvalue etc.

According to the configuration, it is possible to grasp whether which packet is distributed in a unit of a flow, and thus it is possible to grasp a traffic volume at a point where the IP probe is allocated and inter-node communication time (latency) in real time. As a result, it is possible to analyze cause of a network failure in real time.

By installing the IP probe having such a configuration to, for example, a home network as described above, it is possible to specify whether a cause of a network failure is in a network path from a carrier network to the home or in a network device inside the home.

In addition, while packets having identical SIP, DIP, PRCL, SPRT, and DPRT are recorded as the identical flow in the present embodiment, depending on the type of the flow, a value indicating that an entry is invalid is programmed when only SIP and DIP are cared and PRCL, SPRT, and DPRT are not cared, and packet having identical SIP and DIP are handled as the identical flows. By using the present statistical table information, it is possible to detect whether the flows are identical or abnormal based on the minimum necessary information.

Here, the created statistical table information is notified to a server at a specific frequency. This frequency can be set by software for each IP probe, and thus it is possible to set that the statistical table information is notified to the server at a most suitable interval corresponding to network environment. For example, while the information is normally notified to the server at a large frequency such as five minutes, to grasp the situation in more detail at a node where abnormal communication is observed, the notification frequency is increased such that notifying per 10 seconds etc., so that the frequency can be changed corresponding to the status of the network to which the IP probe is connected. These settings are achieved by distributing setting information to each IP probe from the server.

In the notification of the statistical table information, it is not necessary to forward all information and only a flow eigenvalue for discriminating flows and statistical information such as PPS, BPS, etc. are forwarded. Also, by previously setting at the server that forwarding only top-10-level flows having large PPS in each flow etc., a forwarding size can be suppressed with transferring the minimum necessary information to the server.

In this manner, the IP probe of the present embodiment has a feature in forwarding a statistical table to a server at a specific frequency. According to the feature, it is possible to grasp a traffic volume of a network as a whole by a server, which has been unable to be known by conventional IP probes. Consequently, it is easier to find a bottleneck path in the whole network and it is possible to improve throughput as the whole network.

<Method of Parallel Processing on HMCP>

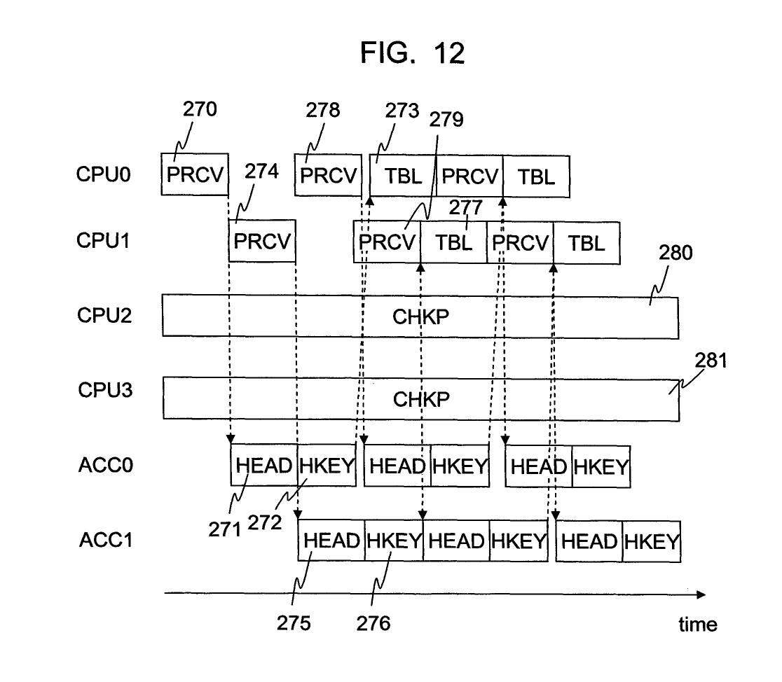

A method of a parallel processing of an IP probe processing at an HMCP will be described. The packet reception (PRCV) 220 is carried out at a CPU, the packet header analysis (HEAD) 221 and the flow eigenvalue calculation (HKEY) 229 are carried out at a DRP which is an accelerator, and the table update processing TBL 230 including a HKEY collision avoiding processing, a table entry update, a packet header update, and a packet transfer is carried out at the CPU as illustrated in the IP probe processing flow in FIG. 9. The packet processing can be a parallel processing in a unit of a packet. A Gantt Chart upon carrying out the IP probe processing on the HMCP configured by four CPUs (CPU0 to CPU3) and two ACCs (ACC0, ACC1) is illustrated in FIG. 12. First, at the CPU0, a packet reception PRCV 270 is carried out. Subsequently, a header analysis HEAD 271 and a flow eigenvalue calculation processing 272 are carried out at the ACC0, and finally, a table update processing TBL 273 is carried out at the CPU0. After the packet reception PRCV 270, a packet reception PRCV 274 is subsequently carried out at the CPU1. In the same manner, a HEAD 275 and a HKEY 276 are carried out at the ACC1, and a TBL 277 is carried out at the CPU1. A next packet reception 278 is carried out at the CPU0, and, in the same manner, a subsequent processing is carried out at the ACC0 and the CPU0.

In this manner, by alternately processing at the CPU0 and CPU1 in parallel, processings can be sequentially carried out to a received packet.

Note that a created statistical table is monitored at the CPU2 and CPU3, and application functions such as abnormal flow detection are carried out.

<Method of Cooperative Processing of IP Probe Node>

Next, an inter-node cooperative method of the IP probe IPP will be described. While a plurality of the IP probes IPP are arranged on the network, the nodes communicate each other, so that the packet status in the whole network is managed.

In the present embodiment, one node communicates only with nodes on an upstream side and a downstream side in a connected communication path and transfers and receives a flow eigenvalue, thereby sharing statistical information of the packet flow and visualizing the packet flows in the whole network as each node communicates with the server.

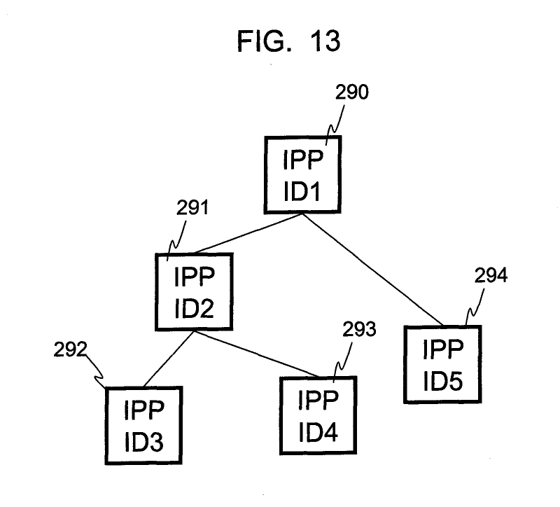

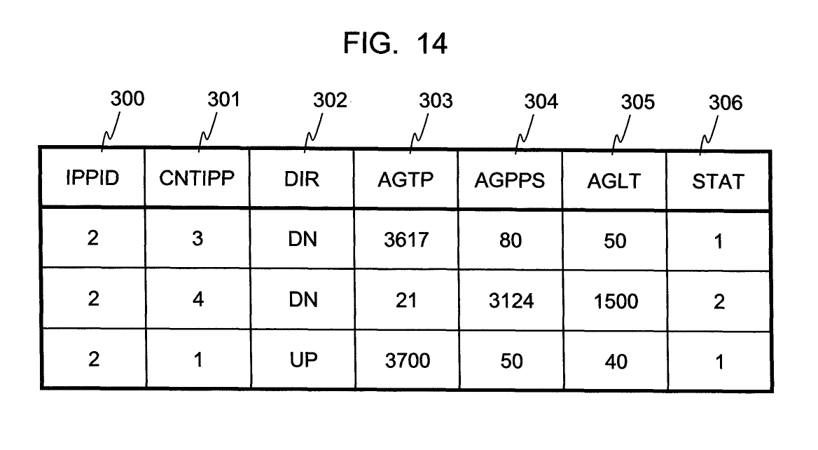

For example, as FIG. 13, it is assumed that the IPP is provided on a network. Each node has a management table as illustrated in FIG. 14. The present table has items of: an ID number (IPPID) 300 of the IPP node itself; an ID number (CNTIPP) 301 of a connection IPP node; a port identification flag (DIR) 302; an inter-node average packet data size (AGTP) 303; an inter-node average packet number (AGPPS) 304; an inter-node average packet transit time (AGLT) 305; an a flow state (STAT) 306. Note that the AGLT is an average of time (latency) for a packet to transit between nodes, and the numerical value is increased due to a lack of performance of a router along with a failure of a device and/or an increase of load. By knowing the value, when, for example, responses of the network service is bad, it is possible to analyze a root cause whether the problem is on the network path side or on the server side providing the service.

Here, an IPPIS2 node 291 in FIG. 13 is focused. The IPPID2 (291) has a connection relation with an IPPID1 (290) at an upstream-side port, and has connection relations with an IPPID3 (292) and an IPPID4 (293) at downstream-side ports.

The inter-node management table indicates connection relations and information of the whole packets between nodes. For example, entries are recorded in a first row, wherein a self node ID is 2, a connection destination ID is 3, a connection port is DN which denotes a downstream port, an average packet data size is 3617 Kbyte/second, an average packet number is 80 packets/second, an average packet transit time is 50 milliseconds, and a status is 1 indicating a normal state.

Also, entries are recorded in a second row, wherein a self ID node is 2, a connection destination ID is 4, a connection port is downstream DN, an average packet data size 21 Kbyte/second, an average packet number is 3124 packets/second, an average packet transit time is 1500 milliseconds, and a state indicating an abnormal state is 2. Here, in the entries in the second row, the average number of packets is much more larger than the average packet data volume, and the packet transit time is much more larger than that in the normal state, and there is a possibility that load on a network device is increased because attacks such as port attacks are underway, and thus the state 2 indicating an abnormal state is recorded. The management table is transferred from each node to the management server SRV, and a copy of the management table is managed as a statistical management table in the whole network on the SRV.

Entries in a third row are recorded, wherein a self ID node is 2, a connection destination ID is 1, a connection port is UP which denotes an upstream port, an average packet data size is 3700 Kbyte/second, an average packet number is 80 packets/second, an average packet transit time is 40 milliseconds, and a state is 1 indicating a normal state.

In this manner, the IP probe of the present embodiment has a feature in creating a management table among nodes by transferring and receiving eigenvalues with IP probes connected at an upstream and a downstream of the IP probe. According to the feature, types of the traffic among nodes, used bandwidths, latency, etc. can be displayed by a map. Further, there is a feature in detecting abnormal communications by comparing the average packet volume and the average number of packets or the inter-node average packet transit time in the management table. Accordingly, it is possible to quickly grasp an abnormality in the network, and also it is possible to promptly respond to a failure.

<Function of Each Node>

Function of each IPP node is streamed from the management server SRV to the IPP. In the present embodiment, a dynamic reconfigurable processor is mounted as the accelerator ACC of the HMCP, and when a new function such as abnormality detection or bandwidth control aiming at security receiving packets of a new standard is desired to be set, it is possible to easily change the management configuration of the network as a whole by distributing program to each node.

<Method of Presenting Network Status>

The server SRV can present the information aggregated by the way described above, communication traffic and status among nodes to administrators and users by a graphical interface (GUI).

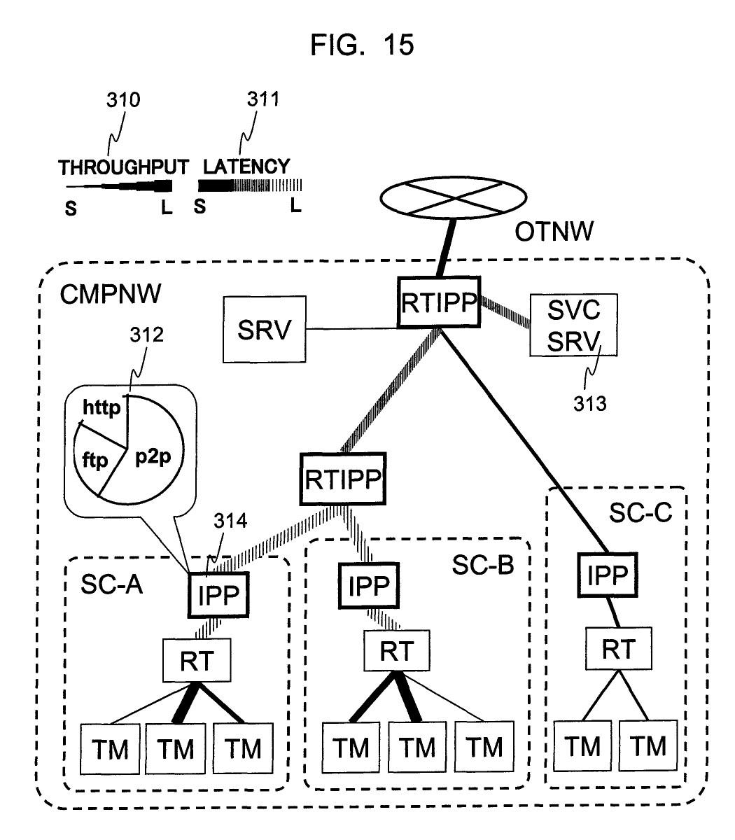

An example of a GUI indicating a status of the network illustrated in FIG. 7 is illustrated in FIG. 15. In the corporate network in FIG. 7, a service server (SVCSRV) 313 which carries out services such as file transfer, e-mail, web server, etc. is added. The server SRV displays connected devices (rectangular boxes) and network topology (lines connecting among devices) from information from the IP probe IPP or the router RTIPP embedding an IP probe. Also, an average data volume, a packet volume, and an average packet transit time among nodes are presented. In the present example, the average packet data size (throughput) (310) is illustrated by the thickness of the line, and the average packet transit time (latency) (311) is illustrated by the color density of the line. More specifically, the thicker the line connecting between nodes, the larger the average data volume, and the thinner the color of the line, the larger the average packet transit time. The way is just an example, and the information can be more effectively presented by using colors. Also, presentations by blinking or using an emphasizing color at a portion in an abnormal state can be considered. Moreover, presenting other indexes like the average packet volume etc. by switching screens can be considered.

As described above, the GUI of the present embodiment has a feature in expressing communication status among nodes by changing the color density of lines, thickness of lines, color of lines, etc. based on the information aggregated by using the above-described IP probe. Also, there is a feature in presenting by emphasizing expressions by blinking or an emphasizing color and in sequentially displaying a plurality of information pieces obtained by the above-described IP probe with switching screens.

According to the features, network administrators and users can understand the current network status intuitively, and also, specification of failure points can be easy, and thus it is possible to quickly correspond to failures.

In addition, a method of presenting breakdown of communication on the nodes by a graph can be considered. For example, in FIG. 15, breakdown of communications on the IPP 314 is illustrated by a circle graph 312. The circle graph 312 illustrates that communications of the hypertext transfer protocol (http) providing WEB page browsing services, the file transfer protocol (ftp), and the inter-node direct communication (p2p) are performed. On the network line to which the IPP 314 is connected, the data volume is large and the latency is also large. To see the breakdown of the communications, the inter-node direct communication p2p occupies at a great rate and so it is understood that this communication is a cause of stressing the network bandwidth.

As described above, the GUI of the present embodiment also has a feature in expressing breakdown of communications in some way like a graph. According to the feature, a cause of pressuring the network bandwidth can be understood by network administrators and users intuitively. Further, based on the feature, it is easy to take a measure of embedding a function of shielding a specific communication or limiting a bandwidth to be used by a specific communication, so that the network quality can be improved.

As described in the foregoing, according to the present invention, a low-power and small IP probe node is achieved, and by arranging a plurality of the IP probes on a network, movement of packets distributed on the network which has been unable to observe can be grasped in real time, and thus an improvement of network quality and a reduction of maintenance management cost are achieved.

### INDUSTRIAL APPLICABILITY

The present invention is, as a means of efficiently analyzing packets flowing on a network, particularly effectively used in a packet analysis apparatus which visualize a status of a network using a heterogeneous multi-core processor including a dynamic reconfigurable processor.

1. An information processing apparatus comprising a processor including: a first processor core having a plurality of logic computing cells; and a second processor core which decides a processing content of the first processor core,
each of the plurality of logic computing cells being changeable about a computing function and a connection relation with the plurality of logic computing cells being adjacent thereto, and
the processor extracting first information from a header of a received packet, and changing the computing function and the connection relation of the first processor core in accordance with the processing content of the first processor core having been decided by the second processor core based on the first information.

2. The information processing apparatus according to claim 1, wherein
the first information is a transfer source IP address, a transfer destination IP address, a transfer source port, a protocol, a transfer destination port or a packet data volume, or alternatively, a combination of these factors, and
the information processing apparatus further comprises a first table recording data of the first information, a total number of packets, a total packet data size, a number of packets per second, a packet data size per second, a packet data volume per second, or a first eigenvalue, or alternatively, a combination of these factors.

3. The information processing apparatus according to claim 2, wherein
the first table is transferred to a server provided to an external portion of the information processing apparatus at a specific frequency.

4. The information processing apparatus according to claim 3, wherein
the information processing apparatus determines whether a plurality of packets to be received are attributed to the same flow or not by referring to a part of the data recorded in the first table.

5. The information processing apparatus according to claim 1, wherein
the processor determines, upon extracting the first information, whether a first eigenvalue indicating which flow the packet is attributed to is included in the header or not, and, if not, adds the first eigenvalue to the header.

6. The information processing apparatus according to claim 1, wherein
the information processing apparatus further comprises:
a bus which connects the first processor core and the second processor core; and
a memory controller which connects the first processor core to a first memory provided to an external portion of the information processing apparatus.

7. The information processing apparatus according to claim 1, wherein
the information processing apparatus further comprises a second memory which records program used by the first processor core, and
the processor decides a next configuration of the first processor core based on information of the first information, and loads the program of the first processor core from the second memory based on the decided configuration.

8. The information processing apparatus according to claim 5, wherein,
when the information processing apparatus is connected to a second information processing apparatus provided to an external portion, the information processing device transfers the first eigenvalue to the second information processing apparatus, and receives a second eigenvalue which indicates which flow information of the second packet is attributed to from the second information processing apparatus, and
the information processing apparatus creates a second table based on the first and second eigenvalues.

9. A network system comprising:
a first information processing apparatus including a first processor having: a first processor core which has a plurality of logic computing cells; and a second processor core which decides a processing content of the first processor core; and
a second information processing apparatus arranged to be adjacent to the first information processing apparatus and including a second processor having:
a third processor core which includes a second processor having a plurality of second logic computing cells; and a fourth processor core which decides a processing content of the third processor core,
each of the plurality of first logic computing cells being changeable about a first computing function and a first connection relation with the plurality of first logic computing cells being adjacent thereto,
the first processor extracting first information from a first header of a first packet having been received, and changing the first computing function and the first connection relation of the first processor core in accordance with the processing content of the first processor core decided by the second processor core based on the first information,
each of the second logic computing cells being changeable about a second computing function and a second connection relation with the plurality of second logic computing cells being adjacent,
the second processor extracting second information from a second header of a second packet having been received, and changing the second logic computing function and the second connection relation of the third processor core in accordance with the processing content decided by the fourth processor core based on the second information,
the first processor determining, upon extracting the first information, whether a first eigenvalue which indicates which flow the first packet is attributed to is contained in the first header or not, and, if not, adding the first eigenvalue to the first header,
the second processor determining, upon extracting the second information, whether a second eigenvalue which indicates which flow the second packet is attributed to is contained in the second header or not, and, if not, adding the second eigenvalue to the second header, and
the first information processing apparatus transferring the first eigenvalue to the second information processing apparatus, receiving the second eigenvalue from the second information processing apparatus, and creating a second table based on the first eigenvalue and the second eigenvalue.

10. The network system according to claim 9, wherein
the second table is an ID number of the first information processing apparatus, an ID number of the second information processing apparatus, a port identification flag, an average packet data volume, an average number of packets, an inter-node average packet transit time, or a flow state, or alternatively, a combination of these factors.

11. The network system according to claim 10, wherein
the second table includes the average packet data volume, the average number of packets, and the inter-node average packet transit time, and
the first information processing apparatus detects an abnormal communication by comparing the average packet data volume and the average number of packets or the inter-node average packet transit time.

12. A method of an information processing comprising:
a first step of extracting first information from a first header of a first packet received by a first information processing apparatus;
a second step of deciding a next configuration of a first processor core which the first information processing device includes based on the first information; and
a third step of switching the first processor core to the configuration decided in the second step.

13. The method of an information processing according to claim 12, wherein
the first information is a transfer source IP address, a transfer destination IP address, a transfer source port, a protocol, a transfer destination port or a packet data size, or alternatively, a combination of these factors, and,
after the first step, the method further comprises a fourth step of creating a first table recording data of the first information, a total number of packets, a total packet data size, a number of packets per second, a packet data size per second, a packet data volume per second, or a flow eigenvalue, or alternatively, a combination of these factors.

14. The method of an information processing according to claim 13, wherein,
after the first step, the method further comprises a plurality of fifth steps of transferring data recorded in the first table to a server provided to an external portion of the information processing apparatus at a specified frequency.

15. The method of an information processing according to claim 14, wherein,
after the fourth step, the method further comprises a sixth step of referring to the data recorded in the first table and determining whether a plurality of packets which the first information processing apparatus receives are in an identical flow or not.

16. The method of an information processing according to claim 12, wherein the method further comprises:
in the first step, a seventh step of determining whether a first eigenvalue indicating which flow the first packet is attributed to is contained in the first header or not;
an eighth step of obtaining the first eigenvalue when the seventh step determines that the first eigenvalue is not contained in the first header; and,
after the eighth step, a ninth step of adding the first eigenvalue to the first header.

17. The method of an information processing according to claim 16, wherein the method further comprises:
a tenth step of transferring the first eigenvalue to a second information processing apparatus being adjacent to and connected to the information processing apparatus, and receiving a second eigenvalue from the second information processing apparatus; and
an eleventh step of recording, based on the first eigenvalue and the second value, an ID number of the information processing apparatus, an ID number of the second information processing apparatus being adjacent and connected, a port identification flag, an average packet data volume, an average number of packets, an inter-node average packet data volume, or a flow state, or alternatively, a combination of these factors, and creating a second table.

18. The method of an information processing according to claim 16, wherein the method further comprises:
a twelfth step of transferring the first eigenvalue to the second information processing apparatus, and receiving a second eigenvalue from the second information processing apparatus;
a thirteenth step of recording an average packet data volume, an average number of packets and an inter-node average packet transit time based on the first eigenvalue and the second eigenvalue; and
a fourteenth step of detecting an abnormal communication by comparing the average packet data volume and the average number of packet data packets or the inter-node average packet transit time.

19. The method of an information processing according to claim 12, wherein,
in the third step, the method further comprises a sixteenth step of loading the configuration decided in the second step from a memory recording configuration information of the first processor core.
